(19) United States
(12) Patent Application Publication
(10) Pub. No.: US 2009/0114321 A1
(43) Pub. Date: May 7, 2009

(54) Pneumatic Tire

(75) Inventor: Norihiko Nakamura, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd, Osaka (JP)

(21) Appl. No.: 12/256,532

(22) Filed: Oct. 23, 2008

(30) Foreign Application Priority Data
Nov. 1, 2007 (JP) 2007-285213

(51) Int. Cl. B60C 19/08

(52) U.S. Cl. 152/152.1

(57) ABSTRACT

A pneumatic tire that can maintain processability and tire performance such as rolling resistance or a wet performance of a tire, overcome the problem of non-conductivity by a tread rubber of silica formulation or the like, and sustain conductive performance of a tire over a long period of time is provided. The pneumatic tire includes a non-conductive tread and a side wall, a rubber member comprising a conductive rubber, penetrating a tread rubber from the outer surface of a cap tread being provided to form a continuous conducting path to a rim via a cap ply, a belt, a carcass and a rim strip, wherein the rubber member includes a rubber composition comprising 100 parts by weight of a rubber component containing from 50 to 100 parts by weight of a diene rubber having a weight average molecular weight (Mw) of from 250,000 to 450,000, and from 10 to 30 parts by weight of carbon black having a nitrogen adsorption specific surface area (N₂SA) of from 700 to 1,300 m²/g and a dibutyl phthalate (DBP) absorption of from 300 to 550 cm³/100 g.

### CROSS-REFERENCE TO RELATED APPLICATIONS

This application is based upon and claims the benefit of priority from the prior Japanese Patent Application No. 2007-285213, filed on Nov. 1, 2007; the entire contents of which are incorporated herein by reference.

### BACKGROUND

The present invention relates to a pneumatic tire. More particularly, it relates to a pneumatic tire having excellent conductivity that has a tread of silica formulation or the like, improves rolling resistance and wet performance of a tire and can discharge static electricity charged in vehicles through a road surface.

To improve rolling resistance of a pneumatic tire and running performance (wet performance) on wet pavement, a technique of compounding silica in place of the conventional carbon black as a reinforcing agent with a rubber composition of a tread. With this silica compounding technique, discharge phenomenon occurs by static electricity charged in vehicles when a tire passes on a manhole or the like, and this gives rise to the problems of radio noise, adverse influence to electronic circuit parts, generation of short-circuit and the like.

To overcome those problems, various techniques of ensuring conductivity of a tire by providing a conductive member having compounded therewith carbon black on a part of a tread structure have conventionally been proposed. For example, the technique disclosed in JP-A-2002-1834 (kokai) is to form a conductive thin film containing carbon black on an outer surface of a tread and a side wall by applying a conductive liquid rubber paste composition to an area of from the vicinity of the part corresponding to the ground end of a tread of a green tire to the part corresponding to a buttress, vulcanizing and molding, thereby covering the entire groove surface of transverse grooves at a tire shoulder.

U.S. Pat. No. 6,140,407 A describes that an aqueous conductive coating containing a rubber component, carbon black having a nitrogen adsorption method specific surface area (N₂SA) of from 70 to 180 m²/g and a dibutyl phthalate (DBP) absorption of from 70 to 180 ml/100 g, and a surfactant is applied over the surface of a tread constituted of a rubber composition having high electric resistance and the surface of a side wall constituted of a rubber composition having low electric resistance adjacent to the tread.

The technique of EP 0 819 741 A2 is that a rubber cement obtained by dissolving and uniformly dispersing a rubber composition comprising 100 parts by weight of a diene rubber and from 40 to 100 parts by weight of carbon black having an N₂SA of 130 m²/g or more and a DBP absorption of 110 ml/100 g or more in an organic solvent is applied to an outer surface of a tire tread cap rubber having an intrinsic resistance value of 10⁸ Ω·cm or more and a part of at least one member adjacent to the outer surface, thereby forming a continuous coating film.

JP-A-10-81110 (kokai) describes that a rubber layer containing specific carbon black and having an intrinsic resistance value of 10⁶ Ω·cm or less and a thickness of from 100 μm to 1 mm is formed as a continuous layer in a circumferential direction in a state of contacting from an outer surface of a tire tread rubber having an intrinsic resistance value of 10⁸ Ω·cm or more to a part of at least one member adjacent to the tread, thereby increasing an antistatic effect, and additionally increasing shelf stability. Furthermore, U.S. Pat. No. 6,183,581 B1 describes that an electrically insulating tread portion is dug, and filled with a cement containing a carbon black mixture containing a volatile liquid, and when the volatile liquid is evaporated, the carbon black mixture remains in the depressed portion, thereby forming a conductive portion conducting to a rotating surface of a tire at the inside of the tread.

However, the techniques described in the above references do not reach to overcome the improvement of low rolling resistance and wet performance by compounding a non-conductive filler such as silica and the problem of non-conductivity of a tire based on a non-conductive tread, in combination. In other words, even though conductivity was improved by providing a conductive thin film comprising a diene rubber containing carbon black having a large specific surface area on the surface of a tire, where carbon black having a large specific area is contained in an amount of 40 parts by weight or more, there were the problems such that the rubber composition becomes highly exothermic, and satisfactory low rolling resistance cannot be achieved; unvulcanization viscosity is increased due to the decrease of dispersibility of carbon black, and this adversely affects processability in production process; and rubber strength of a conductive thin film is decreased with tire running, and conductive performance cannot be sustained over a long period of time.

### SUMMARY

In view of the problems, according to an aspect of the present invention, there is provided a pneumatic tire that can maintain processability of a rubber and tire performance such as rolling resistance or a wet performance of a tire, overcome the problem of non-conductivity by a tread rubber of silica formulation or the like, and sustain conductive performance of a tire over a long period of time.

The pneumatic tire according to the aspect of the present invention comprises a tread forming a ground surface, comprising a non-conductive rubber composition, and other member comprising a conductive rubber, adjacent to the tread in the inside of the tread in a tire radial direction, a rubber member comprising a conductive rubber, penetrating the tread rubber from the outer surface of the tread and contacting at least a part of the other member being provided to form a continuous conducting path of from the outer surface of the tread to a contact region with a rim, wherein the rubber member comprises a rubber composition comprising 100 parts by weight of a rubber component containing from 50 to 100 parts by weight of a diene rubber having a weight average molecular weight (Mw) of from 250,000 to 450,000; and from 10 to 30 parts by weight of carbon black having a nitrogen adsorption specific surface area (N₂SA) of from 700 to 1,300 m²/g and a dibutyl phthalate (DBP) absorption of from 300 to 550 cm³/100 g.

In the aspect of the invention, the total amount of the carbon black contained in the rubber composition is preferably from 50 to 90 parts by weight per 100 parts by weight of the rubber component.

Also, the rubber composition may have electric resistivity of less than 10⁷ Ω·cm.

In the present invention, the rubber member can be formed using a cement rubber comprising the rubber composition dissolved in an organic solvent.

According to the aspect of the present invention, processability of a rubber and tire performance such as rolling resistance or wet performance of a tire by silica formulation are maintained, and additionally conductive performance of a tire can be sustained over a long period of time. Furthermore, problems such as noise, adverse influence to electronic parts or short circuit, due to static electricity charged in vehicles using a non-conductive tire of a silica-formulated tread or the like, can be eliminated.

### BRIEF DESCRIPTION OF THE DRAWINGS

FIG. 1 is a half sectional view of a pneumatic tire according to the first embodiment.

FIG. 2 is a schematic view showing a measurement method of electric resistance of a tire.

FIG. 3 is a half sectional view of a pneumatic tire having SWOT structure.

FIG. 4 is a half sectional view of a pneumatic tire having a wing rubber.

FIG. 5 is a half sectional view of a pneumatic tire according to the second embodiment.

### DETAILED DESCRIPTION

The embodiments of the present invention are described below. The embodiments are described on the basis of an example of a tire for a passenger car, but the invention is not limited thereto.

### First Embodiment

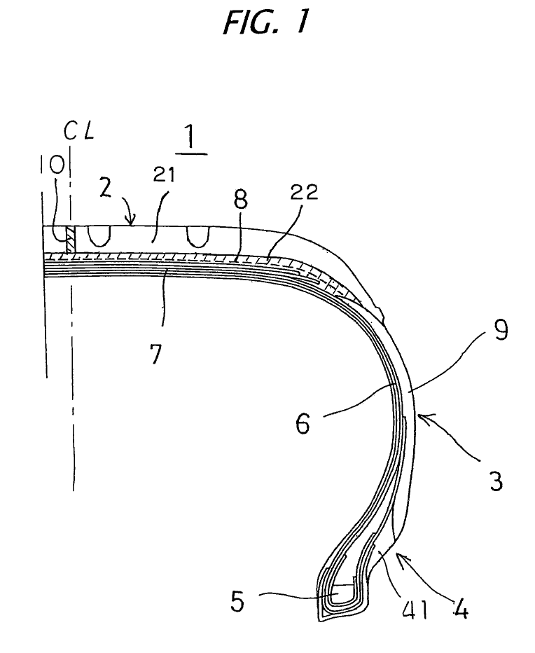

FIG. 1 is a half sectional view of a pneumatic tire 1 according to the embodiment.

The pneumatic tire (hereinafter simply referred to as a “tire”) is constituted of a pair of beads 4 to be mounted on a rim, a side wall 3 extending outwardly in a tire radial direction from the bead 4, and a tread 2 grounded to a road surface, provided between the side walls 3, 3. The tread 2 constitutes a two-layer structure tread comprises a cap tread 21 forming a ground surface at the outside of a tire radial direction, and a base tread 22 in the inside of a tire radial direction of the cap tread 21.

As shown in FIG. 1, the tire 1 is provided with a rim strip 41 contacting a flange of the rim arranged at the outside of a tire axial direction of the bead 4, and the lower edge of the side wall rubber 9 is contacted by superposing on the edge of the rim strip 41. Furthermore, it has a tread over side wall (TOS) structure that the edge at the outside in a tire radial direction of the side wall rubber 9 is superposed on the lower side of the edge of the tread shoulder 22.

Furthermore, the tire 1 shows a tire having a general radial structure for a passenger car, comprising a carcass 6 comprising two carcass plies comprising a cord provided around a bead core 5 embedded in a pair of beads 4, respectively, in a radial direction, the carcass ply being turned outwardly from the inside of a tire and locked, a belt 7 comprising two crossed belt plies provided at the inside of the tread 2, and one cap ply 8 comprising a code spirally wound on the circumference of the belt 7 at an angle of nearly 0° to a circumferential direction of a tire.

The carcass ply of the carcass 6 uses an organic fiber cord such as polyester, nylon or rayon. The belt ply of the belt 7 uses a rigid cord such as a steel cord or an aramide fiber. The cap ply 8 uses a cord having relatively large heat shrinkability, such as nylon or a polyester, as a reinforcing member.

As the tread rubber constituting the tread 2, a rubber composition comprising, as a reinforcing agent, a non-carbon black reinforcing agent such as silica (for example, precipitated silica, anhydrous silicic acid), clay (for example, calcined clay, hard clay), calcium carbonate or the like, in place of the conventional carbon black is used in the cap tread 21 so as to decrease tan δ of the rubber composition in order to contribute to the improvement of rolling resistance and wet performance of the tire. In particular, silica having large improvement effect of rolling resistance or the like is preferably used.

The compounding amount of the non-carbon black reinforcing agent such as silica is from 30 to 120 parts by weight, and preferably from 40 to 100 parts by weight, per 100 parts by weight of the rubber component. Rolling resistance and wet performance can be improved by the compounding amount.

In the case of silica, the kind of silica is not particularly limited. For example, wet silica having a nitrogen adsorption specific surface area (BET) of from 100 to 250 m²/g and a DBP absorption of 100 ml/100 g or more is preferred from the points of reinforcing effect and processability. Commercially available products such as NIPSIL AQ, manufactured by Tosoh Silica Corporation or ULTRASIL VN3, manufactured by Degussa can be used. Furthermore, co-use of a silane coupling agent such as bis(triethoxysilylpropyl)tetrasulfide is preferred.

From the standpoints of abrasion resistance and heat build-up, SAF, ISAF, HAF and the like are preferred as carbon black in the cap tread rubber 21, and its compounding amount is from about 0 to 40 parts by weight per 100 parts by weight of the rubber component.

As the rubber component in the cap tread rubber 21, diene rubbers such as a natural rubber (NR), an isoprene rubber (IR), a styrene-butadiene rubber (SBR) or a butadiene rubber (BR) are used alone or as a blend of two or more thereof. In particular, it is preferred to contain solution polymerized SBR and emulsion polymerized SBR. Furthermore, oils, softeners such as a wax, stearic acid, zinc white, resins, age resisters, vulcanizing agents such as sulfur, vulcanization accelerators or the like that are compounding ingredients for a rubber are appropriately compounded.

By this, the cap tread rubber 21 becomes a rubber improving rolling resistance and wet performance of the tire 1, but on the other hand, the rubber composition has electric resistivity of 10⁸ Ω·cm or more, and therefore forms a non-conductive rubber. As a result, the cap rubber 21 constituting a ground part is non-conductive, and the tire 1 becomes a non-conductive tire having electric resistance of 10⁸Ω or more by the combination of each member.

On the other hand, to ensure strength and fatigue resistance of the tread 2, the base tread rubber 22 uses a rubber composition comprising a diene rubber such as a natural rubber (NR), an isoprene rubber (IR), a styrene-butadiene rubber (SBR) or a butadiene rubber (BR), having compounded therewith mainly carbon black as a reinforcing agent.

The carbon black is preferably grades of HAF, FEF and GPF classes, but is not particularly limited. The compounding amount of the carbon black is from 20 to 100 parts by weight, and preferably from 30 to 80 parts by weight, per 100 parts by weight of the rubber component.

The base tread rubber 22 comprises a rubber composition having compounded therewith carbon black having conductivity, and is therefore constituted of a conductive rubber having electric resistivity of less than 10⁷ Ω·cm.

Furthermore, the side wall rubber 9 and the rim strip rubber 41 use a rubber composition comprising the diene rubber as a rubber component having compounded therewith mainly carbon black as a reinforcing agent.

As the carbon black, the grades of HAF, FEE and GPF classes are preferred for the side wall 9, and its compounding amount is from 20 to 80 parts by weight, and preferably from 30 to 70 parts by weight, per 100 parts by weight of the rubber component. The grades of HAF and FEF classes are preferred for the rim strip 41, and its compounding amount is from 50 to 90 parts by weight, and preferably from 60 to 80 parts by weight, per 100 parts by weight of the rubber component. Therefore, the side wall 9 and the rim strip 41 comprise a rubber composition having compounded therewith carbon black having conductivity, and are therefore constituted of a conductive rubber having electric resistivity of less than 10⁷ Ω·cm.

By this, as shown in FIG. 1, a conducting path continuing the base tread 22, the side wall 3 and the rim strip 41, member edges thereof being in a contact state with each other, and constituted of a conductive rubber composition is formed.

However, the boundary between the cap tread 21 and the base tread 22 are in an insulting state. Therefore, even though a conductive rubber is used in a member other than the cap tread 21, static electricity charged in vehicles cannot be discharged in a road surface from the tread 2 via the rim, the bead 4 and the side wall 3.

To solve the above problem of static electricity charged in vehicles, the tire 1 according to the present embodiment is that a rubber member 10 penetrating the cap tread rubber from the outer surface of the cap tread 21 and contacting the base tread 22 is inserted. By using a conductive rubber in the rubber member 10, a conducting path continuing from the outer surface of the cap tread 21 to the rim strip 41 is formed, and as a result, the problem of static electricity can be eliminated.

Shape and formation method of the rubber member 10 may be any one so long as the conducting path can be ensured. The formation method of a conducting path, such as a method of providing sheet-like rubber members in a circumferential direction or a radial direction of a tire and embedding, a method of embedding columnar rubber members with a certain distance or a method of pouring a cement rubber obtained by dissolving a conductive rubber composition in an organic solvent in cuts provided on the cap tread, is not limited.

The formation position of the conducting path is not limited to the central region of the tread as shown in FIG. 1. The conducting path may be formed in a form of a pair to the central region of the tread, or may be formed at only one side in a tread width direction. Furthermore, the conducting path may be formed in a tire circumferential direction or a tire radial direction continuously or discontinuously.

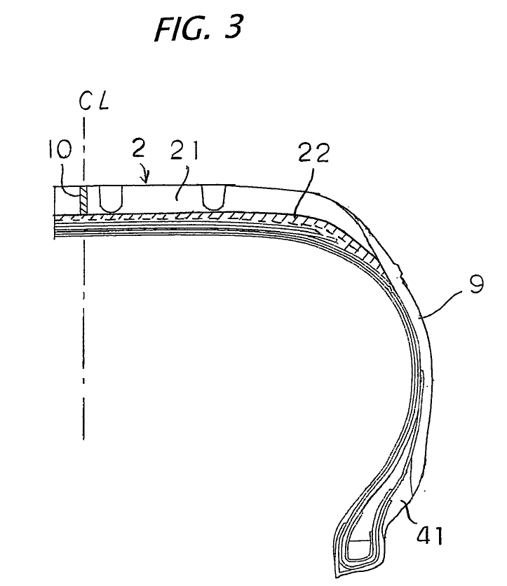

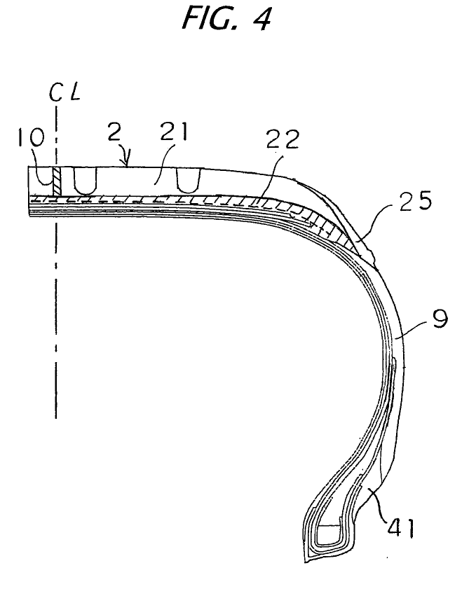

It can be carried out to a tire having a so-called side wall on tread (SWOT) structure in which the outer edge in a tire radical direction of the side wall rubber 9 is superposed on the upper side of the ground edge region of the tread shoulder (see FIG. 3), and a tire having the wing rubber 25 on the tread ground edge region (see FIG. 4).

In the present invention, the rubber composition constituting the rubber member 10 comprises 100 parts by weight of a rubber component containing from 50 to 100 parts by weight of a diene rubber having a weight average molecular weight (Mw) of from 250,000 to 450,000 as a rubber component, and from 10 to 30 parts by weight of carbon black having a nitrogen adsorption specific surface area (N_{2SA) of from} 700 to 1,300 m²/g and a dibutyl phthalate (DBP) absorption of from 300 to 550 cm³/100 g.

Examples of the diene rubber having Mw of from 250,000 to 450,000 include a styrene-butadiene rubber (SBR) and a butadiene rubber (BR), by emulsion polymerization or solution polymerization. It is preferred to contain SBR. Where Mw is less than 250,000, strength of the rubber composition is deficient, and abrasion resistance of the rubber member 10 inserted in a tire is decreased, and partial abrasion is liable to be generated. Where Mw exceeds 450,000, viscosity of an unvulcanized rubber is increased, and as a result, processability such as mixing or extrusion is decreased. Herein, the Mw is the value measured with GPC (gel permeation chromatography), in a solvent: THF (tetrahydrofuran), and at 40° C.

Where the content of the diene rubber in the rubber component is less than 50 parts by weight, viscosity increase of the rubber composition is significant, and processability greatly deteriorates. Furthermore, rolling resistance is not improved.

Preferred examples of the rubber component other than the diene rubber having the specific Mw include a natural rubber, SBR and BR having Mw other than the above range, and a diene rubber such as a polyisoprene rubber.

Where N₂SA of the carbon black is less than 700 m²/g and the DBP absorption thereof is less than 300 cm³/100 g, conductivity of the rubber composition deteriorates, and where the N₂SA exceeds 1,300 m²/g and the DBP absorption exceeds 550 cm³/100 g, dispersibility of carbon black deteriorates, and it is difficult to process with the viscosity increase of an unvulcanized rubber. N₂SA and DBP absorption of carbon black are values measured according to JIS K6217.

Where the compounding amount of the carbon black is less than 10 parts by weight, excellent conductivity cannot be imparted to the rubber composition. Where the compounding amount exceeds 30 parts by weight, dispersibility of the carbon black deteriorates, processability deteriorates with viscosity increase of an unvulcanized rubber, and improvement of rolling resistance is not observed.

The rubber composition preferably contains carbon black other than the above carbon black. When the carbon black other than the above carbon black is co-used in the total amount of carbon black in a range of from 50 to 90 parts by weight, viscosity of an unvulcanized rubber is maintained low and processability can be improved while maintaining conductivity of the rubber composition. Furthermore, solubility in an organic solvent can be improved.

The carbon black other than the above carbon black is not particularly limited, and preferred examples thereof include carbon blacks of HAF, FEF and GPF grades, having relatively large particle diameter.

Oils, softeners such as a wax, stearic acid, zinc white, resins, age resisters, vulcanizing agents such as sulfur, vulcanization accelerators and the like that are compounding ingredients for a rubber are appropriately compounded with the rubber composition.

The rubber composition by the above constitution obtains electric resistivity of less than 10⁷ Ω·cm. By this, the tire 1 has conductivity. By that a continuous conducting path is formed from the bead 4 to a ground surface of the tread 2, conductivity of a tire is ensured, and static electricity of vehicles is discharged in a road surface from the tread 2 via the conducting path.

The rubber member 10 can be formed by penetrating a perforating tool such as a needle (needle-like projection) or a blade (plane blade) in an unvulcanized rubber layer of the tread prepared by extrusion or the like and dividing, or forming cuts or holes and directly embedding the sheet-like or columnar rubber composition in the inside thereof in a solid state, or pouring a cement rubber comprising a rubber composition dissolved in an organic solvent by means of coating, casting or the like and then vulcanizing a tire.

The formation of the conductive rubber member by the above method can be conducted by relatively simple facilities and methods at the time of extrusion of a tread rubber. For example, the conductive rubber member is produced by using a needle having a diameter of about 2 mm and forming through-holes in an extruded tread with a certain distance, and at the same time, filling a solid or liquid cement rubber in spaces formed. By this, influence giving to dimension and precision of an unvulcanized rubber is small. Therefore, adverse influence to uniformity can be minimized as compared with arrangement of a conductive rubber by division/rebonding generally used.

It is preferred to ensure conductivity that the rubber member 10 according to the present invention has a sheet-like form having a thickness of 0.1 mm or more, a nearly cylindrical form (circular form having a diameter of 0.5 mm or more) having a cross-sectional area of 0.2 mm² or more, columnar form such as rectangular column, or the like.

On the other hand, where the thickness of the sheet-like form exceeds 3 mm and the columnar cross-sectional area exceeds 10 mm², there is the possibility that sufficient reinforcement of the rubber member 10 is not obtained in a tire after vulcanization. Furthermore, peeling from the tread rubber is generated, thereby conductivity cannot be maintained, and partial abrasion is generated in the rubber member by running. As a result, there is the case that shielding of a conducting path due to prevention of sufficient contact with a road surface and peeling from the tread rubber are generated.

The cement rubber can use the rubber composition comprising the rubber composition dissolved and uniformly dispersed in an organic solvent. The organic solvent is not limited so long as it has a dissolving ability to the rubber composition. Examples of the organic solvent include volatile oils for rubber, hexane, petroleum ether, heptane, tetrahydrofuran (THF) and cyclohexane. Of those, volatile oils for rubber and hexane are preferred. The rubber composition is dissolved in an organic solvent, and the resulting cement rubber is applied to a tire.

### Second Embodiment

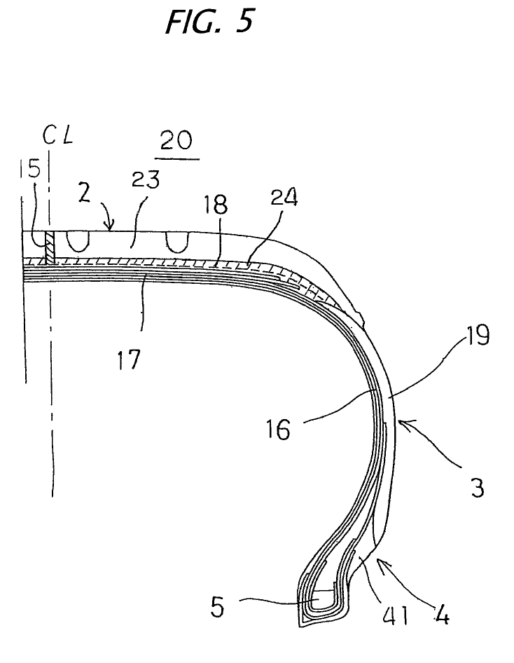

FIG. 5 is a half sectional view showing the pneumatic tire 20 of the second embodiment.

The tire 20 has the same structure as the tire 1, and is constituted of a pair of beads 4 to be rimmed, the side wall 3 extending outwardly in a tire radial direction from the bead 4, and the tread 2 grounding on a road surface provided between the side walls 3, 3. The tread 2 constitutes a two layer structure tread comprising the cap tread 23 forming a ground surface at the outside in a tire radial direction, and the base tread 24 in the inside in a tire radial direction of the cap tread 23.

Furthermore, the tire 20 shows a tire having a general radial structure for a passenger car, comprising a carcass 16 comprising two carcass plies comprising a cord provided around a bead core 5 embedded in a pair of beads 4, respectively, in a radial direction, the carcass ply being turned outwardly from the inside of a tire and locked, a belt 17 comprising two crossed belt plies provided at the inside of the tread 2, and one cap ply 18 comprising a code spirally wound on the circumference of the belt 17 at an angle of nearly 0° to a circumferential direction of a tire.

As the tread rubber constituting the tread 2 of the tire 20, a rubber composition comprising, as a reinforcing agent, a non-carbon black reinforcing agent such as silica (for example, precipitated silica, anhydrous silicic acid), clay (for example, calcined clay, hard clay), calcium carbonate or the like, in place of the conventional carbon black so as to decrease tan δ of the rubber composition in order to contribute to the improvement of rolling resistance and wet performance of a tire 2, or a rubber composition having a reduced compounding amount of carbon black are used in the cap tread 23 and the base tread 24. Thus, the rubber composition comprises a non-conductive rubber having electric resistivity of 10⁸ Ω·cm or more.

Carbon black selected from the grades of ISAF, HAF, FEF and GPF classes may be co-used in the tread rubbers 23, 24. The compounding amount of the carbon black is 30 parts by weight or less, and preferably 20 parts by weight or less, per 100 parts by weight of the rubber component. Where the amount exceeds 30 parts by weight, an effect of improving rolling resistance and wet performance is decreased.

In the present embodiment, to further improve rolling resistance of a tire, a rubber composition using a non-carbon black type reinforcing agent such as silica as a reinforcing agent, or a rubber composition having compounded therewith 40 parts by weight or less of carbon black is used in the side wall 3. The side wall rubber 19 becomes a non-conductive rubber having electric resistivity of 10⁸ Ω·cm or more.

The use method of the non-carbon black type reinforcing agent such as silica is the same as in the first embodiment, and the reinforcing agent is compounded in an amount of from 30 to 120 parts by weight, and preferably from 40 to 100 parts by weight, per 100 parts by weight of the diene rubber component, thereby rolling resistance and wet performance can be improved.

As a result, the tire 20 comprises a non-conductive rubber in a region of from the cap rubber 23 becoming a ground part to the side wall rubber 19, and a non-conductive tire having electric resistance of 10⁸Ω or more is formed as a tire by combining each member.

To solve the problem of non-conductivity, the tire 20 of the present embodiment ensures a conducting path of from a tread ground part to a rim. The same rubber composition as used in the first embodiment is applied to the rubber member 15 comprising a conductive rubber, penetrating the tread 2, and a rubber composition comprising a diene rubber as a rubber component having compounded therewith mainly carbon black as a reinforcing agent, and having electric resistivity of less than 10⁷ Ω·cm is used in covering rubbers of the cap ply 18 contacting the rubber member 15, the belt 18 and the carcass 16, and the rim strip 41.

The covering rubbers of the cap ply 18, the belt 17 and the carcass 16 can use a carbon black-compounded rubber composition conventionally used generally. The carbon black selected from the grades of HAF, FEF, GPE and the like depending on the tire site is compounded with the diene rubber in an amount of from 20 to 100 parts by weight, and preferably from 30 to 80 parts by weight, per 100 parts by weight of the rubber component, thereby electric resistivity is adjusted to less than 10⁷ Ω·cm.

By this, as shown in FIG. 5, all members of the rubber member 15, the cap ply 18, the belt 17, the carcass 16 and the rim strip 41 are contacted with each other, thereby forming a continuous conducting path of from the ground part to the rim. As a result, static electricity charged in vehicles can be discharged in a road surface from an exposed part of the rubber member 15 via the conducting path from the rim, while improving rolling resistance and wet performance of the tire 20 by the tread 2 and the side wall 3.

Formulation of the rubber composition constituting the rubber member 15, and its shape, formation method and formation position are the same as in the first embodiment, and is therefore omitted.

Even in the case that the tread has an integrated structure and a non-conductive rubber composition is used in the entire tread, the present embodiment can similarly be carried out.

### EXAMPLES

The present invention is specifically described below by the following examples, but the invention is not limited to the examples.

Each rubber composition for a rim strip and a cap tread was prepared by kneading a mixture according to the formulation (parts by weight) described in Table 1 using Banbury mixer having a volume of 200 liters by the conventional method. Electric resistivity of each rubber composition is shown in Table 1. A non-conductive rubber composition having compounded therewith 30 parts by weight of carbon black as a reinforcing agent and having electric resistivity of 10¹¹ Ω·cm was used in a base tread, and a conductive rubber composition having compounded therewith carbon black and having electric resistivity of less than 10⁷ Ω·cm was used in covering rubbers of a cap ply, a belt and a carcass.

Next, a rubber composition for a rubber member was prepared by kneading a mixture according to the formulation (parts by weight) described in Table 2 using Banbury mixer having a volume of 200 liters by the conventional method. Processability (Mooney viscosity) and electric resistivity of the rubber composition are measured and shown in Table 2. A rubber component, carbon black and a compounding ingredient used in Tables 1 and 2 are as follows.

### Rubber Component

Natural rubber (NR): RSS#3, made in Thailand

Butadiene rubber (BR): BR150B, manufactured by Ube Industries, Ltd.

Styrene-butadiene rubber 1 (SBR-1): 1723, Mw: 850,000, manufactured by JSR Corporation

Styrene-butadiene rubber 2 (SBR-2): 1502, Mw: 420,000, manufactured by JSR Corporation

Styrene-butadiene rubber 3 (SBR-3): 1507, Mw: 300,000, manufactured by JSR Corporation

### Carbon Black

Carbon black HAF for rim strip rubber: SEAST 3, manufactured by Tokai Carbon Co., Ltd.

Carbon black ISAF for cap tread rubber: SEAST 6, manufactured by Tokai Carbon Co., Ltd.

Carbon black 1 for rubber member (CB-1): SEAST KH, N₂SA: 90 m²/g, DBP absorption: 120 cm³/100 g, manufactured by Tokai Carbon Co., Ltd.

Carbon black 2 for rubber member (CB-2): KETJEN BLACK EC300J, N₂SA: 800 m²/g, DBP absorption: 360 cm³/100 g, manufactured by Ketjen Black International Co.

Carbon black 3 for rubber member (CB-3): KETJEN BLACK EC600JD, N₂SA: 1,270 m²/g, DBP absorption: 500 cm³/100 g, manufactured by Ketjen Black International Co.

### Compounding Ingredient

Silica: NIPSIL AQ, manufactured by Tosoh Silica Corporation

Silane coupling agent: Si69, manufactured by Degussa

Aroma oil: X-140, manufactured by Japan Energy Corporation

Paraffin wax: OZOACE 0355, manufactured by Nippon Seiro Co., Ltd.

Age resister 6C: NOCLAC 6C, manufactured by Ouchi Shinko Chemical Industrial Co., Ltd.

Stearic acid: RUNAX S-20, manufactured by Kao Corporation

Zinc white: Zinc White #1, manufactured by Mitsui Mining & Smelting Co., Ltd.

Sulfur: 5% oil-treated powdery sulfur, manufactured by Hosoi Chemical Industry Co., Ltd.

Vulcanization accelerator NS: NOCCELLAR NS-P, manufactured by Ouchi Shinko Chemical Industrial Co., Ltd.

TABLE 1

| | | Rim strip | Cap tread |
|---|---|---|---|
| | | Conductive | Nonconductive |
| Formulation | NR | 70 | 50 |
| | BR | 30 | |
| | SBR-2 | | 50 |
| | Carbon black | 70 | |
| | Silica | | 60 |
| | Silane coupling agent | | 4 |
| | Aroma oil | 3 | 20 |
| | Wax | 1 | 3 |
| | Age resister | 2 | 2 |
| | Stearic acid | 2 | 2 |
| | Zinc oxide | 3 | 3 |
| | Sulfur | 2 | 2 |
| | Vulcanization accelerator | 1.5 | 1.5 |
| | Electric resistivity (Ω · cm) | 10⁶ | 10¹³ |

A tread having a cap/base structure was molded using a twin-screw extruder for tread. A central portion of the cap rubber was divided in a circumferential direction, and a sheet comprising a rubber composition for a rubber member and having a thickness of 1.1 mm was contacted with a cap ply and inserted so as to expose on the tread surface. An unvulcanized tire having a general structure of a size 195/65R15 as shown in FIG. 5 was molded, and vulcanization molded by the conventional method to prepare a test tire T. Rolling resistance of each tire and electric resistance after running a real car a distance of 1,000 km and a distance of 30,000 km were measured with the following methods. The results obtained are shown in Table 2.

### Processability (Mooney Viscosity)

Mooney viscosity is ML₁₊₄ measured at 100° C. according to JIS K6300. The processability was indicated by an index as Comparative Example 1 being 100. The processability is good as the value is small.

### Electric Resistivity of Rubber Composition

The electric resistivity is a value measured according to JIS K6911. The measurement conditions are that voltage applied is 1,000 V, temperature is 25° C. and humidity is 50%.

### Rolling Resistance

A tire was mounted on a rim of 15×6-JJ with air pressure of 200 kPa, and using a uniaxial drum tester for the measurement of rolling resistance, rolling resistance under a load of 4 kN at 60 km/hr was measured. The rolling resistance is indicated by an index as Comparative Example 1 being 100. Rolling resistance is high and fuel consumption is poor as the value is large.

### Electric Resistance of Tire

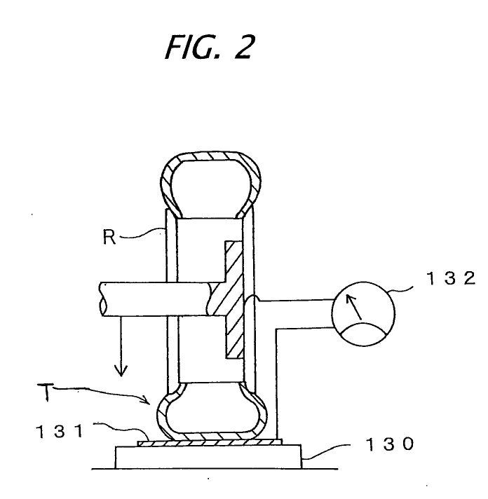

A tire was mounted on a rim of 15×6-JJ with air pressure of 200 kPa, and used in a front-wheel-drive domestic car. After running 1,000 km and after running 30,000 km, electric resistance was measured based on “Measurement Procedures of Electric Resistance of Tire under Load” defined in WDK, Blatt 3 (Germany). That is, as shown in FIG. 2, the tire T mounted on a rim was vertically ground under a load of 4 kN on a copper plate 131 provided in an insulating state to a bedplate 130, and electric resistance between the central portion of a rim R and the copper plate 131 was measured at six positions on the tire circumference using a resistance measuring instrument by applying an applied voltage of 1,000 V. At the time of measurement, temperature was 25° C., and humidity was 50%.

TABLE 2

| | | | | | | Comparative | Comparative | Comparative | Comparative | Comparative |
|---|---|---|---|---|---|---|---|---|---|---|
| | | Example 1 | Example 2 | Example 3 | Example 4 | Example 1 | Example 2 | Example 3 | Example 4 | Example 5 |
| Formulation | SBR-1 | 40 | 40 | 40 | 40 | 100 | 100 | 40 | 40 | 40 |
| | SBR-2 | 60 | | | | | | | | |
| | SBR-3 | | 60 | 60 | 60 | | | 60 | 60 | 60 |
| | Carbon black-1 | 40 | 40 | 30 | 40 | 80 | | | 50 | 20 |
| | Carbon black-2 | 15 | 15 | 25 | | | 40 | 40 | 5 | 35 |
| | Carbon black-3 | | | | 15 | | | | | |
| | Aroma oil | 37.5 | 37.5 | 37.5 | 37.5 | 37.5 | 37.5 | 37.5 | 37.5 | 37.5 |
| | Wax | 2 | 2 | 2 | 2 | 2 | 2 | 2 | 2 | 2 |
| | Age resister | 2 | 2 | 2 | 2 | 2 | 2 | 2 | 2 | 2 |
| | Stearic acid | 2 | 2 | 2 | 2 | 2 | 2 | 2 | 2 | 2 |
| | Zinc oxide | 2 | 2 | 2 | 2 | 2 | 2 | 2 | 2 | 2 |
| | Sulfur | 2 | 2 | 2 | 2 | 2 | 2 | 2 | 2 | 2 |
| | Vulcanization | 1.5 | 1.5 | 1.5 | 1.5 | 1.5 | 1.5 | 1.5 | 1.5 | 1.5 |
| | accelerator | | | | | | | | | |
| Result | Mooney | 100 | 80 | 95 | 90 | 100 | 160 | 110 | 70 | 115 |
| | viscosity | | | | | | | | | |
| | (Index) | | | | | | | | | |
| | Electric | 10⁵ | 10⁵ | 10⁵ | 10⁵ | 10⁵ | 10⁵ | 10⁵ | 10⁵⁻⁶ | 10⁵ |
| | resistivity | | | | | | | | | |
| | (Ω · cm) | | | | | | | | | |
| | Rolling | 98 | 98 | 100 | 100 | 100 | 104 | 104 | 97 | 103 |
| | resistance | | | | | | | | | |
| | (Index) | | | | | | | | | |
| | Electric | 10⁶ | 10⁶ | 10⁶ | 10⁶ | 10⁶ | 10⁶ | 10⁶ | 10⁶⁻⁷ | 10⁶ |
| | resistance | | | | | | | | | |
| | (Ω)*1 | | | | | | | | | |
| | Electric | 10⁶ | 10⁶ | 10⁶ | 10⁶ | 10⁷⁻¹⁰ | 10⁶ | 10⁶ | 10⁹⁻¹⁰ | 10⁶ |
| | resistance | | | | | | | | | |
| | (Ω)*2 | | | | | | | | | |

*1After running 1,000 km
*2After running 30,000 km

It is seen from Table 2 that the pneumatic tire according to the aspect of the present invention ensures conductivity of a tire while maintaining or improving processability (Mooney viscosity) and rolling resistance, and its conductive performance can stably be sustained over a long period of time.

The pneumatic tire according to the aspect of the present invention can be used in four-wheel-cars such as passenger cars or the like, and additionally various vehicles such as two-wheel vehicles such as motorcycles, three-wheel cars, buses or trucks of five-wheels or more, trailers or industrial vehicles.

What is claimed is:

1. A pneumatic tire comprising a tread comprising a non-conductive rubber composition, forming a ground surface, and other member comprising a conductive rubber, adjacent to the tread in the inside of the tread in a tire radial direction, a rubber member comprising a conductive rubber, penetrating the tread rubber from the outer surface of the tread and contacting at least a part of the other member being provided to form a continuous conducting path of from the outer surface of the tread to a contact region with a rim,
wherein the rubber member comprises a rubber composition comprising:
100 parts by weight of a rubber component containing from 50 to 100 parts by weight of a diene rubber having a weight average molecular weight (Mw) of from 250,000 to 450,000, and
from 10 to 30 parts by weight of carbon black having a nitrogen adsorption specific surface area (N₂SA) of from 700 to 1,300 m²/g and a dibutyl phthalate (DBP) absorption of from 300 to 550 cm³/100 g.

2. The pneumatic tire as claimed in claim 1, wherein the total amount of the carbon black contained in the rubber composition is from 50 to 90 parts by weight per 100 parts by weight of the rubber component.

3. The pneumatic tire as claimed in claim 1, wherein the rubber composition has electric resistivity of less than 10⁷ Ω·cm.

4. The pneumatic tire as claimed in claim 2, wherein the rubber composition has electric resistivity of less than 10⁷ Ω·cm.

5. The pneumatic tire as claimed in claim 1, wherein the rubber member comprises a cement rubber obtained by dissolving the rubber composition in an organic solvent.

6. The pneumatic tire as claimed in claim 2, wherein the rubber member comprises a cement rubber obtained by dissolving the rubber composition in an organic solvent.

7. The pneumatic tire as claimed in claim 3, wherein the rubber member comprises a cement rubber obtained by dissolving the rubber composition in an organic solvent.

8. The pneumatic tire as claimed in claim 4, wherein the rubber member comprises a cement rubber obtained by dissolving the rubber composition in an organic solvent.
